(19) United States
(12) Patent Application Publication
(10) Pub. No.: US 2026/0042146 A1
(43) Pub. Date: Feb. 12, 2026

(54) APPARATUS FOR DE-POWDERING

(71) Applicant: Rösler Holding GmbH, Bad Staffelstein (DE)

(72) Inventors: Dominique ZEITLER, Reckendorf (DE); Florian MÜLLER, Ebern (DE)

(21) Appl. No.: 19/288,188

(22) Filed: Aug. 1, 2025

(30) Foreign Application Priority Data
Aug. 12, 2024 (DE) 102024122985.3

(51) Int. Cl. B22F 10/68; B29C 64/30; B33Y 40/20

(52) U.S. Cl. CPC B22F 10/68; B29C 64/30; B33Y 40/20

(57) ABSTRACT

A de-powdering apparatus has a vibration platform that can be lowered and a sieving device. Pumps are provided for discharging the powder and transfer the released powder into a collection container.

### CROSS-REFERENCE TO RELATED APPLICATIONS

This application claims the benefit of German Application No. 102024122985.3, filed on Aug. 12, 2024. The entire disclosure of the application referenced above is incorporated herein by reference.

The invention relates to an apparatus for de-powdering additively manufactured components, by which apparatus released powder can be processed and metered into a container.

The individual parts must be removed from the respective build job (powder cake) for the de-powdering or unpacking of additively manufactured components, for example components manufactured in the SAF, MJF or SLS process. This can take place manually by means of an ejection aid that conveys the build job out of its transport box. The components can then be de-powdered manually, e.g. with brushes or similar hand tools. The released powder can then be processed and reused.

It is the object of the present invention to provide an apparatus for de-powdering additively manufactured components, by which apparatus an automated and efficient de-powdering and a recovery of reusable powder is possible.

This object is satisfied by the features of claim 1 and in particular by an apparatus comprising a vibration platform, which can be lowered and which comprises a powder collector, and a sieving device in fluid connection with the powder collector. A receptacle for a collection container for sieved powder is in fluid connection with the sieving device, wherein two pumping devices are provided. A first pumping device draws powder from the powder collector to the sieving device, while a second pumping device draws powder from the sieving device to the receptacle.

With the apparatus according to the invention, additively manufactured components can be de-powdered highly efficiently by applying them to the vibration platform and then setting the vibration platform into vibration. The powder is hereby released from the powder cake and flows into the powder collector that can, for example, be configured as a collection funnel. This powder can then be drawn from the powder collector to the sieving device with the aid of the first pumping device so that the powder can be sieved in the sieving device. With the aid of the second pumping device, the sieved powder can finally be drawn from the sieving device to the receptacle so that the powder can there be filled into a collection container received in the receptacle. In this way, not only a very cost-effective and fast de-powdering is possible, but also an efficient recovery of powder that was removed from the components and processed by the sieving.

Advantageous embodiments of the invention are described in the description, in the drawing and in the dependent claims.

According to a first advantageous embodiment, the apparatus can be mounted on a chassis. The entire system can hereby be easily transported within a building, i.e. a mobile system is created that can be positioned as required.

According to a further advantageous embodiment, a centrifugal separator can be arranged in the fluid connection between the powder collector and the sieving device. With the aid of such a centrifugal separator, the powder extracted from the powder collector can be separated from the air flow generated by the first pumping device so that the powder can be transferred to the sieving device.

According to a further advantageous embodiment, the first pumping device can be a vacuum pump and the second pumping device can be a powder pump. In this case, the air flow required for an efficient powder transport is generated by the vacuum pump, while the powder pump designed as a solids pump is used to feed the already sieved powder into the receptacle and from there into the collection container.

According to a further advantageous embodiment, the receptacle can comprise a weighing device with which the weight of a collection container can be detected. In this way, the filling level of the collection container can be determined so that a further filling can be stopped at a suitable point in time. With the aid of the weighing device, it can also be determined when the weight of the collection container located in the receptacle no longer increases so that the de-powdering process can then be stopped, for example. Finally, with the aid of the weighing device, a desired maximum filling level of the collection container can be set so that the collection container partly filled with recycled powder can still be completely filled with fresh powder.

According to a further advantageous embodiment, the apparatus has a connection for a fresh powder container, wherein the connection is connected to the second pumping device via a fluid connection that can be shut off by a valve. In this embodiment, a fresh powder container comprising fresh powder can be connected to the connection so that fresh powder can be pumped into the collection container with the aid of the second pumping device. In the de-powdering operation, the fluid connection can be shut off by the valve.

According to a further advantageous embodiment, the apparatus can comprise a fresh powder container that is mounted on its own chassis and that is connected to the connection. In this embodiment, a very flexible system is created since the chassis of the fresh powder container enables a quick and efficient replacement when a fresh powder container has been completely emptied.

According to a further advantageous embodiment, the sieving device can have a valve with which the fluid connection to the second pumping device can be shut off. The fluid connection to the powder collector can hereby be closed when fresh powder is to be pumped from a fresh powder container into the collection container.

According to a further advantageous embodiment, the vibration platform can be arranged in a chute, with a suction opening, which is in fluid connection with the first pumping device, being located at a chute wall, in particular a rear chute wall. In this embodiment, released powder is not only extracted through the powder collector, but also through a wall opening in the de-powdering chamber itself so that no larger powder quantities accumulate at the bottom of the vibration platform.

According to a further advantageous embodiment, a separate fluid connection can be present between the receptacle and the powder collector so that a suction flow is generated between the receptacle of the collection container and the powder collector and draws powder dust from the region of the receptacle during the filling of the collection container.

According to a further advantageous embodiment, the sieving device can be connected to the first pumping device via a fluid connection which can be shut off by a valve and in which a centrifugal separator is arranged, said centrifugal separator in particular being provided with a waste container. In this embodiment, powder residues such as clumps and the like can be sucked off from the upper side of the sieve of the sieving device with the aid of the first pumping device and can be transferred into a waste container if this is necessary.

According to a further advantageous embodiment, the sieving device can be provided with a vibration device and/or an ultrasonic generator in order to set the sieve into high-frequency vibrations and to ensure a constant sieving.

According to a further advantageous embodiment, a shut-off valve can be provided in a fluid connection between the powder collector and the first pumping device. This makes it possible to switch to the above-mentioned operating mode in which residues are sucked off from the surface of the sieve.

According to a further advantageous embodiment, all powder-guiding components can be grounded. A static charge produced by friction is hereby prevented.

According to a further advantageous embodiment, the apparatus can have a control with which the first and the second pumping device can be controlled in dependence on an output signal of the weighing device. This enables the different operating modes already mentioned at the beginning and the setting of a desired mixing ratio between recovered powder and fresh powder.

The present invention will be described in the following purely by way of example with reference to an advantageous embodiment and to the enclosed drawings. There are shown:

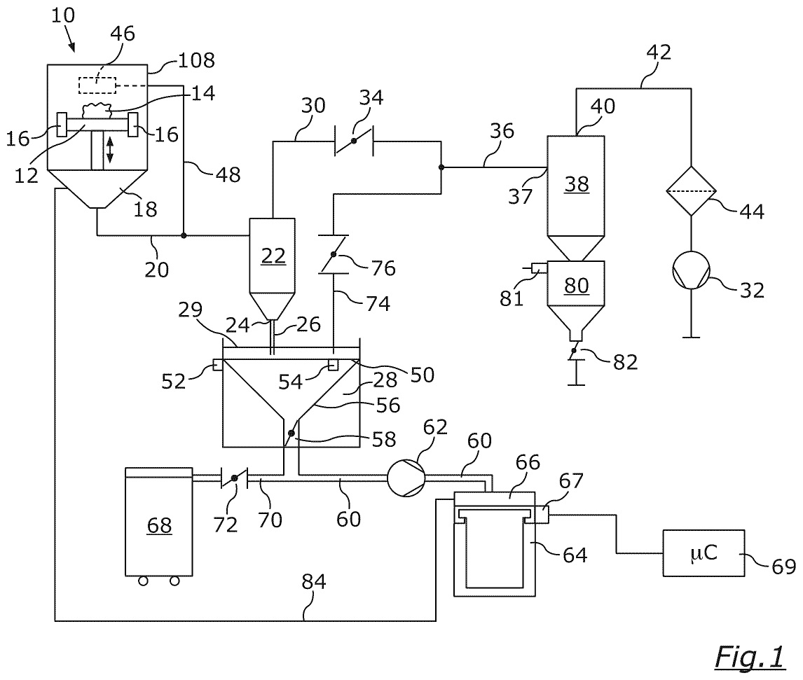

FIG. 1 a schematic diagram of an apparatus for de-powdering;

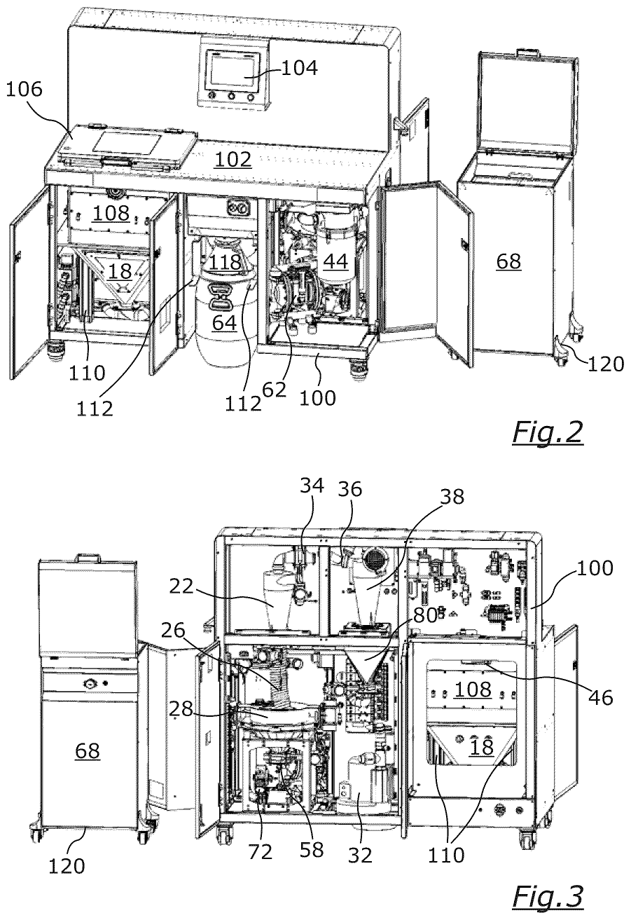

FIG. 2 a perspective front view of the apparatus;

FIG. 3 a perspective rear view of the apparatus of FIG. 2;

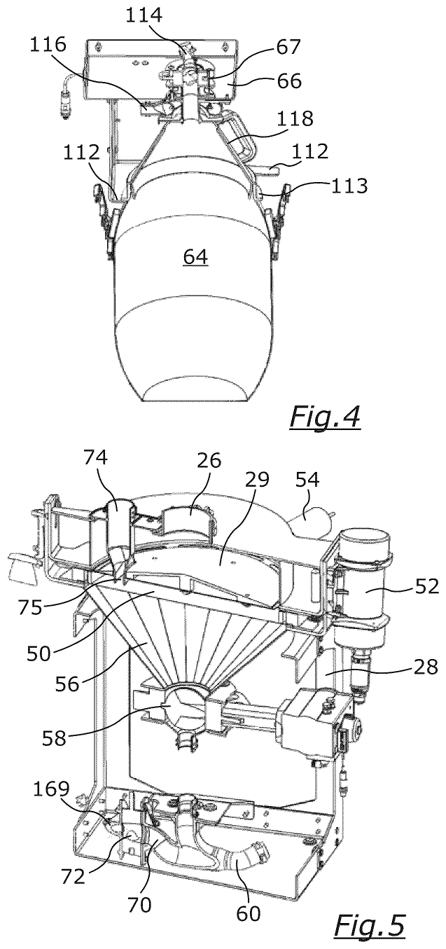

FIG. 4 a sectioned view of a receptacle with a collection container; and

FIG. 5 a sectioned view of a sieving device.

The main components of the apparatus shown in FIG. 2 and FIG. 3 for de-powdering additively manufactured components are schematically shown in FIG. 1. The apparatus comprises a de-powdering station 10 comprising a vibration platform 12 which can be lowered and in which additively manufactured components to be de-powdered are arranged. The vibration platform 12 can, for example, be provided with vibration drives 16 and can be perforated so that released powder can enter a powder collector 18 that is designed as a collection funnel in the embodiment example shown. The vibration platform 12 is arranged in a chute 108 of the de-powdering station 10, which chute has, at a rear side wall, a suction opening 46 that is connected to a fluid line 20 via a fluid line 48 so that powder can be drawn off through the suction opening 46.

At the lower end of its collection funnel, the powder collector 18 is connected via a fluid line 20 to a first centrifugal separator 22 whose lower product outlet 24 is connected via a fluid line 26 to a sieving device 28. The transport air of the first centrifugal separator 22 is guided via a fluid line 30 from the upper side of the first centrifugal separator 22 to a first pumping device 32 in the form of a vacuum pump (e.g. a side channel compressor), wherein a shut-off valve 34 is arranged in the fluid line 30. The shut-off valve 34 is connected via a fluid line 36 to an air inlet 37 of a second centrifugal separator 38 whose upper transport air connection 40 is connected to the first pumping device 32 via a fluid line 42. A fine particulate filter 44 is located between the second centrifugal separator 38 and the first pumping device 32.

For the de-powdering, the vibration platform 12 is set into vibration and the first pumping device 32 is activated so that it generates an air flow that conveys released powder from the powder collector 18 via the fluid line 20 to the first centrifugal separator 22. There, the powder is separated from the air flow and flows through the fluid line 26 to the sieving device 28.

The sieving device 28 has a fine sieve 50 that serves to sieve the powder fed through the fluid line 26. For this purpose, the fine sieve 50 is equipped with a vibration device 52 and/or an ultrasonic device 54 to assist the sieving process. The sieved powder then passes into a collection funnel 56 at whose outlet a shut-off valve 58 is provided. Via a fluid line 60, in which a second pumping device 62 is arranged, the sieved powder can be transferred into a collection container 64 that is received in a receptacle 66.

Furthermore, a fresh powder container 68 can be provided that is connected to the fluid line 60 via a further fluid line 70. In the fluid line 70, there is a further shut-off valve 72 that can be closed in the de-powdering operation. To supply fresh powder, the shut-off valve 58 is closed and the shut-off valve 72 is opened so that fresh powder is transferred from the fresh powder container 68, the fluid line 70, the fluid line 60 and the second pumping device 62, which can, for example, be configured as a diaphragm pump, into the receptacle 66 and from there into the collection container 64.

Finally, for cleaning the surface of the fine sieve 50, a fluid line 74 is connected to the sieving device 28 and is guided into the fluid line 36, wherein a shut-off valve 76 is arranged in the fluid line 74. The fluid line 74 continues above the surface of the fine sieve 50 and into an intermediate space between the fine sieve 50 and a perforated cover 29 of the sieving device 28 so that, by operating the first pumping device 32 with the shut-off valve 34 closed and the shut-off valve 76 open, powder residues can be drawn from the fine sieve 50 and transferred into the second centrifugal separator 38. From there, the residues enter a waste container 80 that is arranged below the second centrifugal separator 38. The product outlet 80 of the waste container can be closed by a further shut-off valve 82 that is only opened when the waste container 80 needs to be emptied.

Finally, a separate fluid line 84 is present between the receptacle 66 and the powder collector 18 to generate a suction flow that extracts powder dust from the chute 108 of the de-powdering station 10.

As FIG. 1 further illustrates, the receptacle 66 is provided with a weighing device 67 that detects the weight of a collection container 64 arranged in the receptacle 66 and transmits the detected weight to a control 69 which is only shown schematically and to which all the pumps and shut-off valves as well as the further electrical units are connected.

FIGS. 2 and 3 each show a perspective front view and rear view of the apparatus described above. Said apparatus is mounted on a chassis 100 that can be provided with rollers and that forms a base frame for the de-powdering apparatus. A table 102, above which an operating unit 104 is arranged, is located on the base frame. Furthermore, a pivot flap 106 is located on the table 102 and closes an opening which is present in the table 102 and through which a build job can be introduced into the chute 108 of the de-powdering station 10. Two parallel sliders are located under the flap 106 and can be positioned from the right and the left at a build job to position the latter. To transfer the build job, it is transferred, with the pivot flap 106 open, onto the table 102 and onto the vibration platform 12 that at this point in time has been raised so far that it is flush with the surface of the table 102. The build job is hereby prevented from reaching a drop height and possibly being damaged as a result.

After transferring the build job 14 to the vibration platform 12, the latter is lowered by means of pneumatic cylinders 110 into a lower end position in which said vibration platform 12 is located at the upper edge of the funnel-shaped powder collector 18. In this respect, build jobs with a height of over 30 cm can be processed. The pivot flap 106 can then be closed so that the vibration drives 16 can be activated. The platform 12 supported on rubber dampers is hereby set into vibration so that powder is released from the build job 14 and falls through openings in the vibration platform 12 into the powder collector 18. In addition, the de-powdering process can be assisted by a pressurizing with compressed air that is introduced into the interior of the chute 108 through nozzles.

To transfer the powder located in the powder collector 18 into the sieving device 28, the first pumping device 32 is activated that can be designed as a side channel compressor, for example. Said first pumping device generates a negative pressure in the flow path that is formed by the fluid lines 20, 30, 36 and 42. At the same time, in the region of the suction opening 46, powder dust is extracted from the chute 108 through the fluid line 48.

The powder conveyed in this way into the first centrifugal separator 22 falls through the fluid line 26 into the sieving device 28 and onto the fine sieve 50 there.

FIG. 5 shows an enlarged and sectioned representation of the sieving device 28. Said sieving device is mounted on a base frame and contains the fine sieve 50 that is arranged above the collection funnel 56. The fine sieve 50 can set into vibration with the aid of at least one vibration drive 52 and/or the ultrasonic device 54 so that the powder fed through the fluid line 26 is sieved and falls into the collection funnel 56. When the second pumping device 62 is activated, this powder, when the shut-off valve 72 is closed, is sucked out through the fluid line 60 and transferred into the collection container 64. FIG. 5 further shows that, in the region of the sieving device 28, there is a connection 169 to which the fluid line 60, which leads to the fresh powder container 68, can be connected. Said fresh powder container is mounted on its own chassis 120 and has a pivot flap at the upper side.

FIG. 4 shows a sectioned and enlarged representation of the receptacle 66 with the collection container 64 introduced. As can be seen in FIG. 4 and also in FIG. 2, the receptacle 66 has two parallel forks 112 onto which the collection container 64 can be pushed with its circumferential flange 113. To facilitate this process, the base frame 100 is formed at its front side such that there is a free space between a floor and the receptacle 66 in the region of the receptacle 66. When the collection container 64 is located on the forks 112 of the receptacle 66, it is arranged slightly above the floor so that the weight of the collection container 64 can be detected with the aid of the weighing device 67.

The reference numeral 114 in FIG. 4 designates a connection port for the fluid line to the second pumping device 62. The reference numeral 116 designates a connection port for the fluid line 84. Finally, the receptacle 66 is provided with a conical cover 118 that completely covers the opening of the collection container 64.

For cleaning the fine sieve 50 of the sieving device 28, above the fine sieve 50, a suction port 75 is provided, through which powder lumps and the like can be sucked off through the fluid line 74. After the shut-off valve 76, the fluid line 74 continues into the fluid line 36 and the latter leads into the second centrifugal separator 38 whose transport air connection 40 is connected to the fluid line 42. When the shut-off valves 34 and 58 are closed and the shut-off valve 76 is open, powder waste can hereby be sucked into the centrifugal separator 38 and transferred from there into the waste container 80 located therebelow. The waste container 80 can be emptied as required by opening the shut-off valve 82. To recognize when the waste container 80 is full, a filling level sensor is arranged at its upper side and is connected to the control 69.

To de-powder the build job 14, it is transferred into the de-powdering station 10, as described above, to start the de-powdering process. When pumps 32 and 62 are activated, released powder is transported from the powder collector 18 into the sieving device 28 and is pumped from there into the collection container 64. Due to the signal of the weighing device 67, it can in this respect be determined when the weight of the collection container 64 no longer increases. In this case, the de-powdering process is complete. However, the de-powdering can also be terminated beforehand, for example, if the collection container 64 has reached a predetermined weight. In this case, by switching off the first pumping device 32, by closing the shut-off valve 58 and by opening the shut-off valve 72, it is possible to pump fresh powder from the fresh powder container 68 into the collection container 64 with the aid of the second pumping device 62. In this respect, any desired mixing ratios can be set using the control 69.

To clean the fine sieve 50, the shut-off valves 34 and 58 are closed and the shut-off valve 67 is opened so that, with the aid of the first pumping device 32, powder residues can be fed from the sieve surface through the fluid line 74 and 36 into the second centrifugal separator 38 and can be separated there into the waste container 80.

An automated de-powdering with a powder recovery rate of over 90% and a metering accuracy between recovered and fresh powder in the order of magnitude of ±75 g for a total volume of up to 12 kg of an entire print job can be efficiently achieved with the apparatus described above. Due to the sieving of the powder in the sieving device, a consistent quality is furthermore ensured. Since all the powder-guiding parts are grounded in the apparatus described above, an electrostatic charging is reliably avoided.

1. An apparatus for de-powdering additively manufactured components, comprising
a vibration platform that can be lowered and that comprises a powder collector,
a sieving device in fluid connection with the powder collector,
a receptacle, which is in fluid connection with the sieving device, for a collection container for sieved powder, and
a first pumping device that draws powder from the powder collector to the sieving device, and
a second pumping device that draws powder from the sieving device to the receptacle.

2. The apparatus according to claim 1,
wherein it is mounted on a chassis.

3. The apparatus according to claim 1,
wherein a centrifugal separator is arranged in the fluid connection between the powder collector and the sieving device.

4. The apparatus according to claim 1,
wherein the first pumping device is a vacuum pump and the second pumping device is a powder pump.

5. The apparatus according to claim 1,
wherein the receptacle comprises a weighing device with which the weight of a collection container located in the receptacle can be detected.

6. The apparatus according to claim 1,
wherein it has a connection for a fresh powder container, said connection being connected to the second pumping device via a fluid connection that can be shut off by a valve.

7. The apparatus according to claim 6,
further comprising a fresh powder container that is mounted on its own chassis and that is connected to the connection via a fluid connection.

8. The apparatus according to claim 1,
wherein the sieving device has a valve with which the fluid connection to the second pumping device can be shut off.

9. The apparatus according to claim 1,
wherein the vibration platform is arranged in a chute, with a suction opening, which is in fluid connection with the first pumping device, being located at a chute wall.

10. The apparatus according to claim 9,
wherein the chute wall is a rear chute wall.

11. The apparatus according to claim 1,
wherein a separate fluid connection is present between the receptacle and the powder collector.

12. The apparatus according to claim 1,
wherein the sieving device is connected to the first pumping device via a fluid connection which can be shut off by a valve and in which a centrifugal separator is arranged.

13. The apparatus according to claim 12,
wherein centrifugal separator is provided with a waste container.

14. The apparatus according to claim 1,
wherein the sieving device is provided with a vibration device and/or an ultrasonic generator.

15. The apparatus according to claim 1,
wherein a shut-off valve is provided in a fluid connection between the powder collector and the first pumping device.

16. The apparatus according to claim 1,
wherein all the powder-guiding components are grounded.

17. The apparatus according to claim 5,
wherein it has a control with which the first and the second pumping device can be controlled in dependence on an output signal of the weighing device.
